(19) United States
(12) Patent Application Publication
(10) Pub. No.: US 2007/0210107 A1
(43) Pub. Date: Sep. 13, 2007

(54) SNAP-ACTION FLANGE

(75) Inventors: Andreas Pleschinger, Anthering (AT); Rene Hendler, Judendorf/Strassengel (AT)

Correspondence Address: SEED INTELLECTUAL PROPERTY LAW GROUP PLLC, 701 FIFTH AVE, SUITE 5400, SEATTLE, WA, 98104, US

(73) Assignee: BLECKMANN GMBH & CO. KG, Lamprechtshausen (AT)

(21) Appl. No.: 11/671,952

(22) Filed: Feb. 6, 2007

(30) Foreign Application Priority Data
Feb. 6, 2006 (DE) 10 2006 005 321.4

(51) Int. Cl. B67B 5/00

(52) U.S. Cl. 222/153.06

(57) ABSTRACT

A flange unit for holding a heating device to a fluid container of an appliance accommodating a fluid to be heated, in particular a domestic appliance, comprising a flange body 12 which is made from a non-metallic material and which can be mounted to a fluid container 60 by at least one fixing device 20, wherein said fixing device 20 is formed by at least one fixing element 22 which can be brought into positively locking engagement with the fluid container 60.

### CROSS-REFERENCE TO RELATED APPLICATION

This application claims priority to German application No. 10 2006 005 321.4, filed Feb. 6, 2006 which application is incorporated herein by reference in its entirety.

### BACKGROUND OF THE INVENTION

1. Field of the Invention

The invention concerns a flange unit for holding a heating device to a fluid container of an appliance accommodating a fluid to be heated, in particular a domestic appliance. The invention further concerns a heating system which includes at least one heating device for heating a fluid, in particular in a domestic appliance, a flange unit for holding the heating device and a fluid container for accommodating the fluid to be heated by the heating device.

2. Description of the Related Art

The flange units which are used in practice at the present time substantially comprise five individual components, namely the actual flange body which is usually made of steel, a seal, a clamping portion with press-fit pins, a nut and a flat grounding plug. The procedure for assembling the pre-assembled flange unit in the mounting or installation opening of a fluid container of a domestic appliance such as for example a washing machine or a dishwashing machine provides that the nut is tightened. As a result the clamping portion experiences a relative movement and compresses the seal which is disposed between the flange body and the clamping portion. That causes the cross-section of the seal to be enlarged and it thus seals off the entire system against the fluid container, while at the same time the flange unit is fixed to the mounting opening.

That previously known flange unit suffers from disadvantages such as the large number of individual components which comprise different materials and which are each to be produced separately. In addition it is necessary to apply a relatively high force in assembly of the flange unit in order to ensure that the unit is securely sealed off in relation to the container. Consequently the sealing element is of a comparatively massive configuration, and that in turn has an adverse influence on costs.

In addition, European patent application No 1 111 962 discloses a flange unit which has a main body of plastic material, a sealing element and a fixing device in the form of a wedge. For the purposes of fixing the pre-assembled flange unit in the mounting opening on the fluid container it is introduced into the mounting opening. The fixing wedge is then pushed into a slot opening provided for that purpose in the center of the main body. The main body is increased in width by virtue of the fixing wedge being pushed thereinto in that way and is thus fixed in the mounting opening. That solution entails at least three components which have to be handled by the fitter during the operation of fitting the flange unit.

As generally flange units or heating systems of that kind are subject to a high level of cost pressure, the number of components involved, the choice of material and the number of handling steps in pre-assembly of the flange unit and final assembly thereof to the fluid container have a great influence on the economic viability of a flange unit or a heating system respectively. Therefore the above-described known flange units or heating systems are disadvantageous as they involve a large number of components and require a large number of fitting steps.

One object of the present invention is to provide a flange unit and a heating system of the kind set forth in the opening part of this specification, which while affording the same or better efficiency and reliability, permit a marked reduction in manufacturing costs, in comparison with the previously known flange units or heating systems.

### BRIEF SUMMARY OF THE INVENTION

In one embodiment a flange unit for holding a heating device to a fluid container of an appliance accommodating a fluid to be heated, in particular a domestic appliance, comprises a flange body which is made from a non-metallic material and which can be mounted to a fluid container by at least one fixing device, wherein said fixing device is formed by at least one fixing element which can be brought into positively locking engagement with the fluid container, wherein the positively locking engagement of the at least one fixing element on the fluid container is formed by a latching engagement, wherein the at least one fixing element is formed by a snap-action or latching element which can be brought into engagement with a counterpart snap-action device provided on the fluid container, wherein the at least one fixing element is resilient, and wherein the fixing device is provided to peripherally extend at least approximately completely around the flange body.

The provision of a fixing device on a flange unit in such a way that it is formed by at least one fixing element which can be brought into positively locking engagement with the fluid container affords the possibility of providing a solution which is very simple and involves only few components and is thus inexpensive for fitting the flange unit to the fluid container and thus mounting the heating device for heating the fluid in the fluid container. As will be shown further hereinafter the positively locking engagement of the fixing element to the fluid container affords a large number of advantages which have a considerable influence in particular on cost reduction.

The provision of the positively locking connection at least approximately completely around the flange body, when the flange unit is mounted to the mounting opening of the fluid container, enables a holding force which acts in the direction of the center point of the mounting opening and which holds the flange unit securely and possibly in sealing relationship at the mounting opening as it acts at least approximately on all sides from the entire periphery of the flange unit in the direction of the center of the mounting opening.

In this respect the term positively locking connection is used to denote in particular the interengagement of contour portions of the at least one fixing element with at least one counterpart fixing element provided on the fluid container, for example by latching engagement between the fixing elements. In that respect the most widely varying shapes and configurations can be selected for the contours of the fixing elements. A particularly advantageous solution according to a certain embodiment involves a latching hook-shaped configuration for the fixing element on the flange body and the counterpart fixing element on the fluid container, while another suitable contour such as for example an arcuate leg can also be provided for the counterpart fixing element.

In principle the positively locking interengagement of the fixing element on the flange body with the corresponding counterpart fixing element on the fluid container can take place irreversibly. In order however to permit dismantling of the heating device or the entire heating system it is further advantageous if the at least one fixing element can be reversibly brought into engagement with the fluid container.

As already mentioned hereinbefore any contour portions can be selected for the at least one fixing element for affording the positively locking engagement with the fluid container. As has also already been mentioned hereinbefore, in one embodiment, the at least one fixing element is formed by a snap-action or latching element which can be brought into engagement with a counterpart snap-action or latching device provided on the fluid container. Equally, however, it is also conceivable that, with a suitable configuration in terms of sealing integrity the wall of the fluid container has only one opening with an undercut configuration, into which the snap-action or latching element of the at least one fixing element of the flange unit engages.

In order to afford a certain pre-stressing to prevent release of the positively locking connection between the at least one fixing element and the fluid container, in one embodiment, in one embodiment, the at least one fixing element is of a resilient nature. In that case the resiliency of the fixing element can be formed by a property of the material of the element or by a structural configuration of the fixing element on the flange body. That can be effected for example by the provision on the flange body of slot-shaped incisions which, when the flange unit is installed, extend substantially perpendicularly to the wall of the fluid container or at least approximately parallel to the axis of the mounting opening on the fluid container. It will be appreciated however that a structural configuration is also possible by weakening the flange body at the transition from the at least one fixing element to the flange body. It is to be noted that the resiliency of the at least one fixing element can also be achieved by a combination of the elastic property of the material and a structural configuration in respect of the fixing element.

In order to be able to provide that the flange unit is securely mounted to the fluid container, in one embodiment, the fixing device is provided at least approximately completely around the flange body. By way of example that can be effected by the provision at the side of the flange body, that in the installed condition faces towards the fluid container, of a peripherally extending latching nose which is possibly resiliently reversibly deflectable out of its initial position.

In order to prevent fluid in the fluid container from issuing to the surrounding area in the installed condition, in one embodiment, the flange body is provided with at least one sealing means for fluid-tightly sealing it off in relation to the fluid container in the installed condition. In that case the at least one sealing means can be formed by a property of the material of the flange body or by at least one sealing element which is provided on the flange body and which in a further development comprises EPDM or TPE. It will be appreciated that a combination of those two solutions is also possible.

In order further to simplify the structure of the flange unit and in particular to be able to complete the handling procedure involved in pre-assembly of the flange unit to the heating device or in final assembly of the flange unit to the fluid container by a few handling steps, in one embodiment, the at least one sealing element is connected integrally to the flange body, which is made in a further development by injection molding therearound.

So that secure reliable sealing integrity can be ensured it is further provided that the sealing means extends at least completely around the flange.

As already mentioned hereinbefore the flange unit serves to receive and hold at least one heating device. In that respect the heating device can be formed by a heating cartridge or by a tubular heater which is bent for example in a U-shape or a W-shape. Depending on the respective number of connecting ends of the heating device, which are to be passed to the outside of the fluid container, the flange unit can be provided with one or more through openings. In order here also to provide sealing integrity to prevent the fluid in the fluid container from escaping to the surrounding area, the at least one through opening for receiving and holding at least one heating device can be provided with at least one sealing means. In that case once again the at least one sealing means can be formed by a property of the material of the flange body or by at least one sealing element which is made, in a further development, from EPDM or TPE. It will be appreciated that in this case also a combination of a sealing means comprising a property of the material of the flange body and a sealing element is possible.

So that the number of handling steps involved in pre-assembly of the heating device to the flange unit is also low, in one embodiment, the at least one sealing element is connected integrally to the at least one through opening, which is made, in a further development, by being injection molded therearound. If the at least one sealing means extends at least approximately completely around the at least one through opening, complete sealing integrity can be ensured.

Besides the heating device, further components which are necessary for controlling or regulating the heating device and thus for controlling or regulating the heating action for the fluid can also be arranged through the flange body of the flange unit. So that those components can be securely held by the flange body, it can further be provided that the flange body has at least one holding device for receiving and holding at least one control or regulating device. In that case the holding device for receiving and holding at least one control or regulating device can be formed by a pocket which is provided on the flange body and which is, in a further development, integrally shaped thereon. In that arrangement the opening of the pocket can be closed off on the one hand in the direction of the side which faces towards the fluid container in the installed condition of the flange body. If the control device involves a temperature detection device the bottom of the pocket around which the fluid flows can be designed in such a fashion that the temperature of the fluid can be reliably detected. There is also the possibility of establishing the response characteristics on the part of the control or regulating device in accordance with the configuration of the bottom of the pocket.

Alternatively, the pocket can be sealingly closed off in opposite relationship to the direction of the side that faces towards the fluid container in the installed condition of the flange body. In such a case the control device is fitted into the pocket in a fluid-tightly encapsulated housing and is appropriately fixed there.

In order to simplify final mounting of the flange body and the heating device to the fluid container, it can also be provided that the flange body is injection molded to the heating device. That configuration provides that the flange body of the flange unit and the heating device form a one-piece component which can be easily fixed to the fluid container.

Any desired non-metallic material and in particular any plastic material can be used for the material of the flange unit. It has proven to be particularly advantageous if the flange body is made from polypropylene.

In regard to the heating system, the foregoing object is attained by a heating system including at least one heating device for heating a fluid, in particular in a domestic appliance, a flange unit for holding the heating device and a fluid container for accommodating the fluid to be heated by the heating device, wherein the fluid container has at least one through opening for passing the heating device therethrough and for mounting the flange unit, wherein the flange unit is designed according to a particular embodiment thereof as described herein, and that the fluid container has at least one through opening for passing the heating device therethrough and for mounting the flange unit, which fluid container has at least one counterpart fixing device facing away from the fluid container into the outside direction and which counterpart fixing device is arranged for a positively locking connection of the flange unit to the fluid container, and wherein the latching element peripherally extends at least approximately completely around the through opening in the wall of the fluid container.

In respect of the advantages of the heating system which uses the flange unit according to embodiments of the invention attention is to be directed to the foregoing description.

### BRIEF DESCRIPTION OF THE SEVERAL VIEWS OF THE DRAWINGS

Further advantageous configurations of the invention and a number of embodiments by way of example in respect thereof are described in greater detail hereinafter with reference to the accompanying drawing. The terms used in the description of the specific embodiments ‘left’, ‘right’, ‘up’ and ‘down’ relate to the drawing in an orientation in which the Figure designations and references can be normally read. In the drawings:

FIG. 1 shows a partly sectional perspective view of the heating system according to one embodiment of the invention with the flange unit according to one embodiment of the invention and the heating device held thereto in the installed condition on a fluid container,

FIG. 2 shows a two-dimensional plan view of the sectioned flange unit of FIG. 1,

FIG. 3 shows a sectional view on an enlarged scale of a flange body of the flange unit according to one embodiment,

FIG. 4a shows a sectional view of the flange body of the embodiment of FIG. 3 without the inner wall portion,

FIG. 4b shows a sectional view of the inner wall portion of the flange body of the embodiment of FIG. 3 without the flange body,

FIG. 5 shows a development of the flange body of the embodiment shown in FIG. 3,

FIG. 6 shows a sectional view on an enlarged scale of the flange body of the flange unit according to a further embodiment, and

FIG. 7 shows a further development of the flange body of the embodiment shown in FIG. 3.

### DETAILED DESCRIPTION OF THE INVENTION

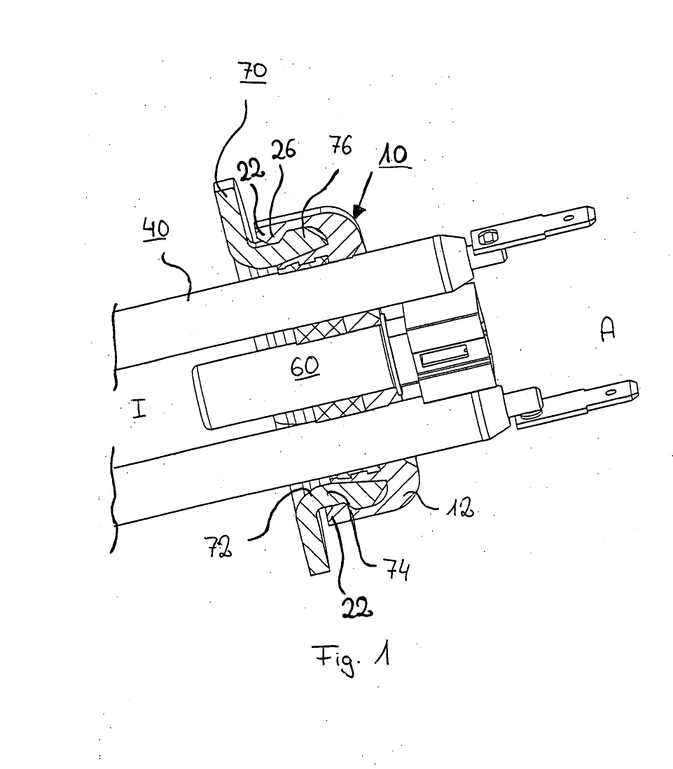

FIG. 1 shows one illustrating example of a heating system according to the invention with its components: an embodiment of the flange unit 10 which is also based on the principles of the invention, an electrical resistance heating device 40 in the form of a tubular heater, a control or regulating device 60 for controlling or regulating the heating operation for the fluid to be heated by the resistance heating device 40 and a fluid container 70 for receiving the fluid to be heated by the heating system. The individual units or components of the heating system are described hereinafter.

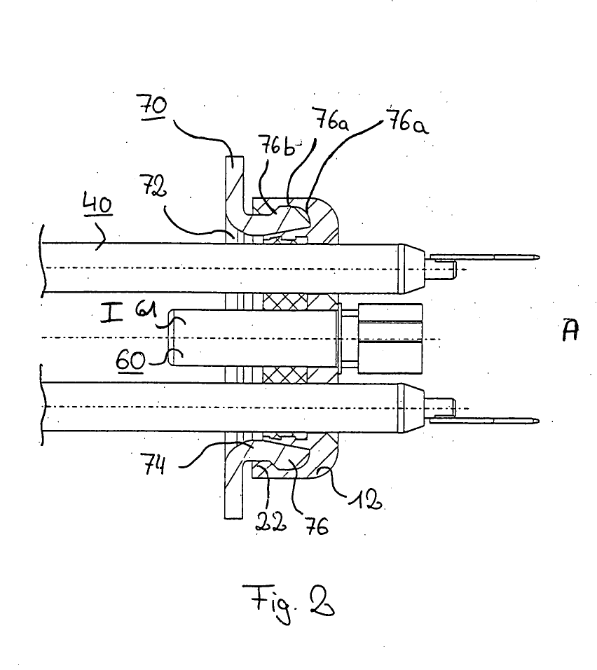

As can be seen from FIGS. 1 through 4b the flange unit 10 may include a flange body 12 which in plan view is substantially in the form of an elongate oval, the long sides of which extend in substantially mutually parallel relationship and the shorter sides of which are provided with the oval rounded configurations. The flange body 12 has a first flange or longitudinal side 12a which faces away from the fluid container 70 in the installed condition of the flange unit 10. In addition the flange body 12 has a second flange or longitudinal side 12b which extends in parallel relationship with the first longitudinal side 12a and which in the installed condition of the flange unit 10 faces in the direction of the fluid container 70 or projects into the interior of the fluid container 70, as can be seen for example from FIGS. 1 and 2. The two longitudinal sides 12a and 12b are connected together by a peripheral side 12c extending substantially perpendicularly to those two longitudinal sides 12a, 12b. As can be seen from FIGS. 1, 3 and 4a the peripheral side 12c goes into the first longitudinal side 12a by way of an arc 12d whereas the peripheral side 12c meets the second longitudinal side 12b perpendicularly at an angle of 90°.

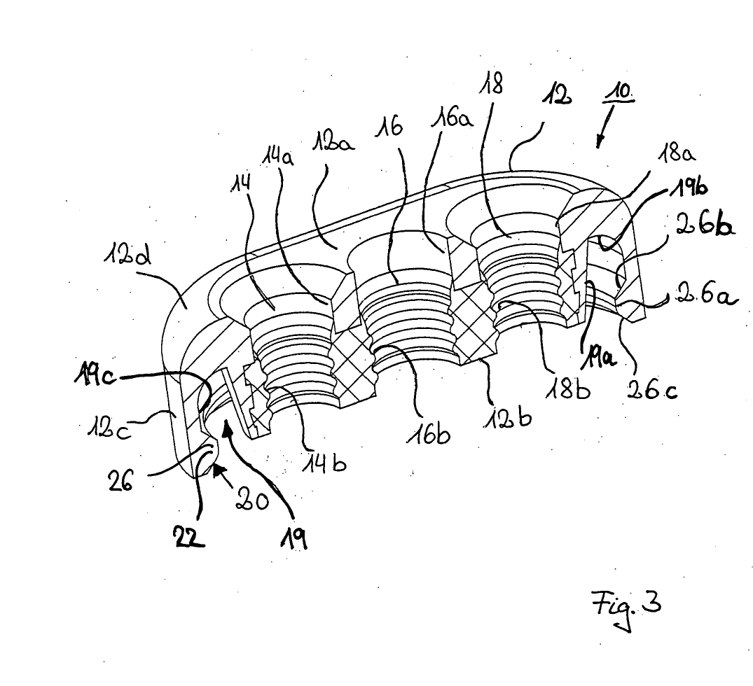

In the embodiment shown in FIGS. 1 through 6 the flange body 12 has a total of three through openings 14, 16, 18 whose longitudinal center lines (not identified in greater detail) extend in perpendicular relationship to the flange or longitudinal sides 12a, 12b and in mutually parallel relationship, as can be seen from FIGS. 2 and 3. The through openings 14, 18 serve for mounting or holding the electrical resistance heating device 40 and the through opening 16 serves for mounting or holding the control or regulating device 60 for controlling or regulating heating of the fluid which is to be heated by the resistance heating device 40.

As can be seen from FIGS. 2 and 3 the through openings 14, 16, 18 or the longitudinal center lines thereof are disposed at equal spacings from each other considered in the plane of the first or second flange or longitudinal side 12a, 12b. All three through openings 14, 16, 18 are the same in terms of their geometrical configuration, with the difference that the diameter of the central through opening 16 is larger than the diameter of the two through openings 14, 18 arranged at the left and the right of the central through opening 16. The diameter of those two through openings 14, 18 is identical. It is therefore sufficient to describe in greater detail hereinafter only the structure and configuration of the through opening 16. Insofar as there are also further minor differences between the three through openings 14, 16, 18, they will be described in greater detail during the description of the structure of the through opening 16.

As can further be seen from FIG. 3 the through opening 16 is of an at least approximately circular-cylindrical cross-section. In addition it has two different inner wall portions 16a, 16b (and 14a, 14b; 18a, 18b respectively) which adjoin each other in succession in the axial direction of the through opening 16 from the first flange or longitudinal side 12a and which extend to the second flange or longitudinal side 12b. The first inner wall portion 16a is formed by a cylindrical inner wall configuration. In the two through openings 14, 18, that cylindrical portion 14a, 14b also has a chamfer which opens in the direction of the outside. The second inner wall portion 16b which directly adjoins the first inner wall portion 16a has an inner wall contour which is wave-shaped in longitudinal section. In that respect the inside diameter both of the wave peaks and also the wave troughs is smaller than the inside diameter of the first inner wall portion 16a. The second inner wall portion 16b serves for affording sealing integrity at the components of the heating system according to embodiments of the invention, that are passed through the through openings 14, 16, 18, in relation to discharge of the fluid to be heated by the heating system. In that arrangement the inside diameter of the second inner wall portion 16b is slightly less than the outside diameter of the respective component passing therethrough of the heating system according to embodiments of the invention so that the inner wall portion is compressed by the introduction of the respective component into the associated through opening 14, 16, 18.

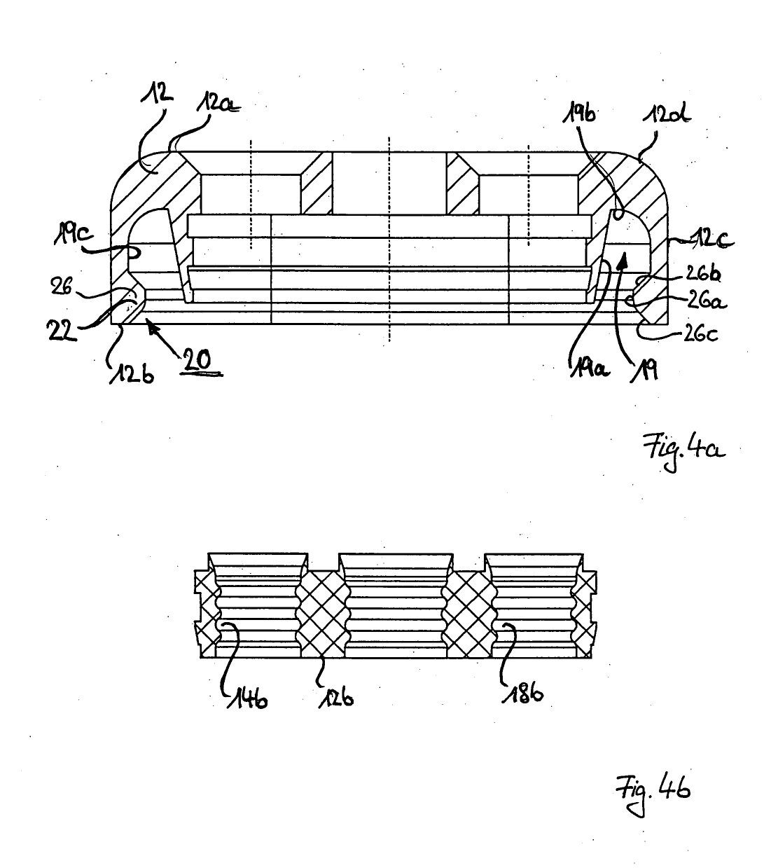

In the embodiment of FIGS. 1 through 5 and 7 the second inner wall portion 16b is made from a material which is different from the material of the flange body 12 in order further to improve the sealing effect. By way of example the flange body 12 can be made from polypropylene (PP) and the inner wall portion 16b and 14b, 18b respectively can be made from an ethylene/propylene/diene polymer (terpolymer) rubber (EPDM) or a thermoplastic elastomer (TPE), in which respect a two-component injection process can be used to produce such a flange body 12. FIGS. 4a and 4b show the two parts of the flange body 12, which are produced from different materials, in greater detail. In that respect FIG. 4a shows the flange body without the inner wall portions 16b and 14b, 18b respectively which are made from another material, while FIG. 4b shows them ‘liberated’.

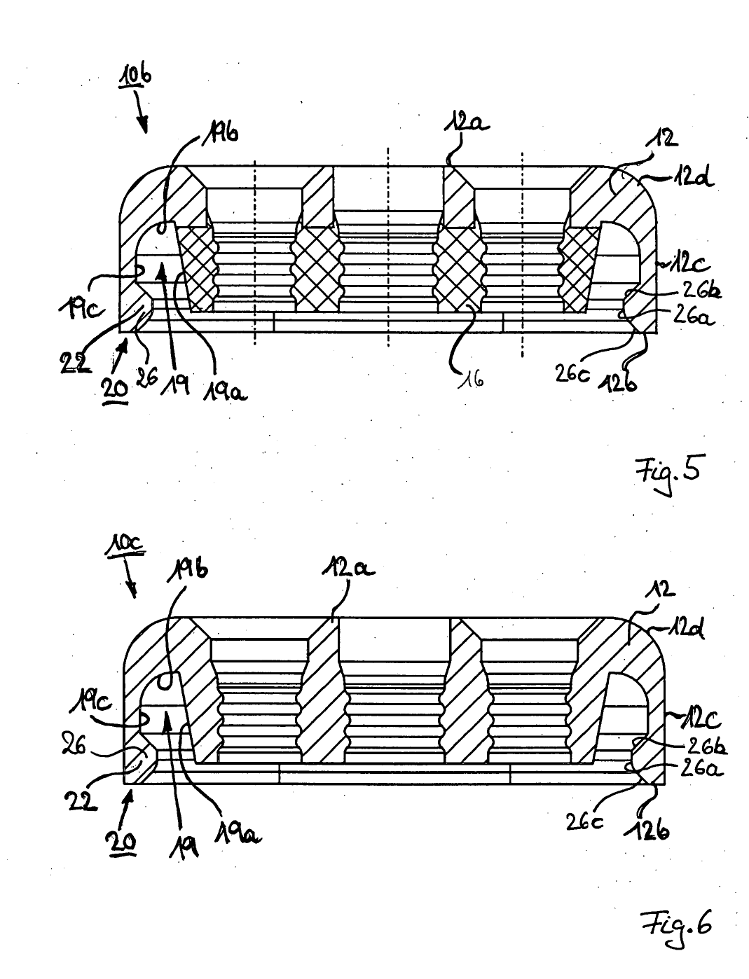

FIG. 5 shows an advantageous development of the flange body 12 of the flange unit 10a of the embodiment of FIGS. 3 through 4b, wherein the inner wall portion 16b or 14b, 18b respectively is of a configuration pulled to the cone of the container wall 70. By virtue thereof manufacture of the flange unit is simpler and an even better sealing action is achieved by virtue of a more appropriate distribution of pressure.

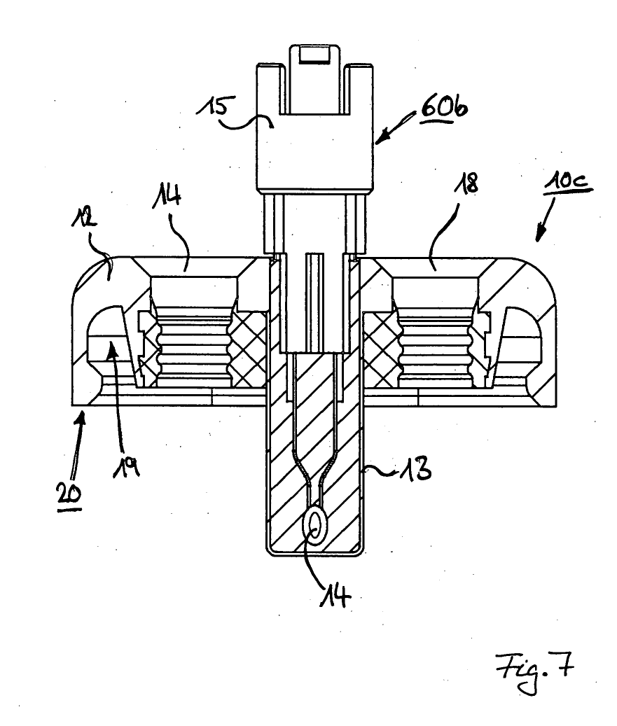

As an alternative thereto FIG. 6 shows a further embodiment of the invention wherein the flange body 12 of the flange unit 10b—as a ‘one-piece’ variant—can be made throughout from a material which is suitable for affording the sealing effect such as for example an EPDM or a TPE. According to a further development, the flange body 12 is produced from a material which covers both the snap-action property and also the required sealing property. Here for example a thermoplastic material with elastomer proportions such as PP filled with an EPDM has proven to be appropriate as the material involved. The flange body 12 can then be produced in the form of an injection molded member or with a suitable elastomer, for example an EPDM, in the form of a vulcanized article.

Referring to FIGS. 1 through 7 the flange body 12 of the flange or longitudinal side 12b also has a peripheral groove 19 extending along its peripheral side 12c. In that arrangement the first groove 19a which faces in the direction of the through opening 14, 16, 18 is straight at an acute angle relative to the longitudinal center lines of the through openings 14, 16, 18, considered in the longitudinal sectional view in FIG. 2. In the groove bottom 19c that groove wall 19a goes at an angle of 90° into an arc which is adjoined by the second groove wall 19c.

A fixing device 20 which is formed integrally on the flange body 12 is provided in the region of the end of the groove wall 19c, that faces towards the flange or longitudinal side 12b. The fixing device 20 which extends peripherally completely along the groove 19 is formed by a fixing element 22 in the form of a latching projection 26 whose projection tip 26a faces in a direction towards the through openings 14, 16, 18. As can be seen from FIGS. 3, 4a, 5 and 6 the latching projection 26 is provided with a straight inclined surface at its side 26b which faces away from the fluid container 70 while it is provided with a rounding configuration 26c at the side which faces towards the fluid container 70. The rounding configuration 26c assists with mounting of the flange body 12 to the fluid container 70, as will be further described hereinafter. Upon mounting of the flange unit 10 or the heating system the latching projection 26 comes into engagement with a counterpart latching projection 76 on the fluid container 70, as will also be described in greater detail hereinafter.

As already mentioned hereinbefore the through openings 14, 16, 18 serve to receive and hold the electrical resistance heating device 40 and the control or regulating device 60 for controlling or regulating heating of the fluid which is to be heated by the resistance heating device 40. In particular the connecting ends (not shown in greater detail) of the resistance heating device 40 are pushed into the respective through openings 14, 18, as can be seen from FIGS. 1 and 2. The inside diameter of the two through openings 14, 18 is matched to the diameters of the portions 42a, 42b of the tubular casing 42 of the heating device 40, which portions in the mounted condition of the heating device 40 are disposed in the interior of the through openings 14, 16, 18, while the inside diameter of the two through openings 14, 18 is of such a size that a stiff, tight joining fit is afforded between in particular the inner wall portions 14a, 14b; 18a, 18b of the through openings 14, 18 and the outside of the tubular casing portions 42a, 42b of the heating device 40. Alternatively or supplemental thereto, the tubular casing portions 42a, 42b can be fixed in the through openings 14, 18 by an adhesive which at the same time can provide for sealing integrity of the through openings 14, 18. Optionally however the flange body 12 can also be overall injection molded around the tubular casing portions 42a, 42b of the heating device 40.

In the embodiment shown in FIGS. 1 through 6, provided between the two through openings 14, 18 is a further through opening 16 in which the control or regulating device 60 for controlling or regulating heating of the fluid to be heated by the resistance heating device 40 is fitted, which in the illustrated embodiment is formed by an NTC element. The NTC element is arranged in a steel sleeve 62 whose end which faces in the direction of the interior of the container is closed off. In this case also the inside diameter of the through opening 16 is matched to the external contour of the control or regulating device 60 and the dimensions are such that the arrangement also involves a tight joining fit. Alternatively or supplemental thereto, it is possible once again to provide an adhesive which at the same time can provide for the sealing integrity of the through opening 16. If the flange body 12 is injection molded to the heating device 40, the flange body 12 can also be injection molded to the control or regulating device 60. Equally however it is also possible for the flange body 12 to be injection molded to the heating device 40 and for the control or regulating device 60 to be inserted into the central through opening 16 and fixed there in a suitable fashion.

FIG. 7 shows an alternative configuration of the flange unit 10c in which the control or regulating device 60b for controlling or regulating heating of the fluid to be heated by the resistance heating device is inserted into a pocket 13 which is integrated into the flange 12. In that way it is possible for the control or regulating device 60b to be integrated into the flange 12 directly without a sealing means. For that purpose a suitable sensor, for example an NTC element 14, together with the plug unit 15, can have the flange material injection molded therearound in production of the flange 12, or it can be fitted by casting in a pot-shaped pocket 13 in the flange. In that way it is possible to dispense with the high-quality steel pot (61 in FIG. 2) for the sensor, which is otherwise required and which in use is in contact with the fluid to be heated.

As can be seen from FIGS. 1 and 2 the fluid container 70 has a mounting opening 72. That mounting opening 72 is of a shape which is complementary to the flange body 12. Provided at the edge of the mounting opening 72, that faces away from the inside I of the container, is a collar 74 which in plan view is also of a shape that is complementary to the flange body 12. In particular the mounting opening 72 and the collar 74 are in the form of an elongate oval. Arranged at the free end of the collar 74 is a counterpart fixing device in form of a counterpart latching projection 76 which, together with the latching projection 26 of the flange body 12, involves a positively locking latching connection when the flange body 12 is mounted to the mounting opening 72 of the fluid container 60. In particular the counterpart latching projection 76 has a projection tip 76a which faces in a direction towards the interior of the mounting opening 72. As can be seen from FIG. 2 the counterpart latching projection 76 is provided with a straight inclined surface at its side 76b which faces in the direction of the inside I of the container and at its side 76c which faces towards the outside A of the container.

For mounting the heating system according to certain embodiments in position firstly the flange body 12 of the flange unit 10 is produced, for example by an injection molding operation. Then the heating device 40 and the control or regulating device 60 can be inserted into the respective through opening 14, 16, 18. Optionally, the heating device 40 or the control or regulating device 60 can be glued in the respective through opening 14, 16, 18. Alternatively, as has already been described hereinbefore, the flange body 12 can be injection molded to the tubular casing portions 42a, 42b of the heating device 40, optionally together with the control or regulating device 60. The arrangement which is pre-assembled in that way is then inserted into the mounting opening 72 of the fluid container 70.

In that situation the latching projection 26 of the flange body 12 slides with its rounding configuration 26b which faces in the direction of the inside I of the container, against the corresponding counterpart surface 76c of the counterpart latching projection 76 and in so doing is resiliently deflected outwardly in a direction parallel to the two flange or longitudinal sides 12a, 12b. After the two latching projection tips 26a, 76a have slid past each other the latching projection 26 pivots back again into its starting position in a direction towards the through openings 14, 16, 18. When that happens the latching surface 26b of the latching projection 26 comes into positively locking engagement with the latching surface 76b of the counterpart latching projection 76. In that situation the collar 74 engages partly into the groove 19 of the flange body 12. By virtue thereof, and in particular by virtue of the embracing relationship of the fixing device 20 or latching projection 26 which peripherally extends completely around the flange body 12 with the counterpart latching projection 76 the flange unit 10 is held fixedly to the fluid container 70. Insofar as the material of the flange body 12 comprises a plastic material which allows a sealing action such as for example EPDM or TPE, the positively locking engagement of the fixing device 20 or the latching projection 26 with the counterpart latching projection 76 seals off the mounting opening 72. Optionally however it is additionally possible to use a sealing element which is provided on the latching projection 26 and/or the counterpart fixing device in form of the counterpart latching projection 76.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A flange unit for holding a heating device to a fluid container of an appliance accommodating a fluid to be heated, in particular a domestic appliance, comprising a flange body which is made from a non-metallic material and which can be mounted to a fluid container by at least one fixing device,
wherein said fixing device is formed by at least one fixing element which can be brought into positively locking engagement with the fluid container,
wherein the positively locking engagement of the at least one fixing element on the fluid container is formed by a latching engagement,
wherein the at least one fixing element is formed by a snap-action or latching element which can be brought into engagement with a counterpart snap-action device provided on the fluid container,
wherein the at least one fixing element is resilient, and
wherein the fixing device is provided to peripherally extend at least approximately completely around the flange body.

2. A flange unit as set forth in claim 1 wherein the at least one fixing element can be brought reversibly into engagement with the fluid container.

3. A flange unit as set forth in claim 1 wherein the resiliency of the at least one fixing element is formed by a material property of the fixing element.

4. A flange unit as set forth in claims 1 wherein the resiliency of the at least one fixing element is formed by a structural configuration of the fixing element on the flange body.

5. A flange unit as set forth in claim 1 wherein the flange body is provided with at least one seal for fluid-tight sealing in the installed condition in relation to the fluid container.

6. A flange unit as set forth in claim 5 wherein the at least one seal is formed by a material property of the flange body.

7. A flange unit as set forth in claim 5 wherein the seal is formed by at least one sealing element provided on the flange body, preferably comprising EPDM or TPE.

8. A flange unit as set forth in claim 7 wherein the at least one sealing element is integrally connected to the flange body, in particular by injection molding therearound.

9. A flange unit as set forth in claim 5 wherein the seal peripherally extends at least approximately completely around the flange body.

10. A flange unit as set forth in claim 1 wherein the flange body has at least one through opening for receiving and holding at least one heating device.

11. A flange unit as set forth in claim 10 wherein the at least one through opening for receiving and holding at least one heating device is provided with at least one seal.

12. A flange unit as set forth in claim 11 wherein the at least one seal is formed by a material property of the flange body.

13. A flange unit as set forth in claim 10 wherein the at least one seal is formed by at least one sealing element, preferably comprising EPDM or TPE.

14. A flange unit as set forth in claim 13 wherein the at least one sealing element is integrally connected to the at least one through opening, preferably by injection molding therearound.

15. A flange unit as set forth in claim 11 wherein the at least one seal peripherally extends at least approximately completely around the at least one through opening.

16. A flange unit as set forth in claim 1 wherein the flange body has at least one holding device for receiving and holding at least one control device.

17. A flange unit as set forth in claim 16 wherein the holding device for receiving and holding at least one control device is formed by a pocket provided on the flange body.

18. A flange unit as set forth in claim 17 wherein the pocket is fluid-tightly closed off in the direction of the side which in the installed condition of the flange body faces towards the fluid container.

19. A flange unit as set forth in claim 17 wherein the pocket is sealingly closed off in opposite relationship to the direction of the side which in the installed condition of the flange body faces towards the fluid container.

20. A flange unit as set forth in claim 17 wherein the pocket is integrally formed on the flange body.

21. A flange unit as set forth in claim 1 wherein the flange body can be injection molded on the heating device.

22. A flange unit as set forth in claim 1 wherein the flange body is made from polypropylene.

23. A heating system including at least one heating device for heating a fluid, in particular in a domestic appliance, a flange unit for holding the heating device and a fluid container for accommodating the fluid to be heated by the heating device, wherein the fluid container has at least one through opening for passing the heating device therethrough and for mounting the flange unit,
wherein the flange unit is designed as set forth in claim 1 and that the fluid container has at least one through opening for passing the heating device therethrough and for mounting the flange unit, which fluid container has at least one counterpart fixing device facing away from the fluid container into the outside direction and which counterpart fixing device is arranged for a positively locking connection of the flange unit to the fluid container, and
wherein the latching element peripherally extends at least approximately completely around the through opening in the wall of the fluid container.

24. A heating system as set forth in claim 27 wherein the counterpart fixing device is formed by at least one latching element which comes into preferably resilient and/or reversible engagement with the fixing element on the flange body.

25. heating system as set forth in claim 23 wherein the through opening in the wall of the fluid container is at least approximately of an oval shape and the flange body is of a shape which is complementary thereto.

26. A heating system as set forth in claim 23 wherein the flange body is injection molded to the heating device.

27. A heating system as set forth in claim 23 wherein the flange body is pushed on to the heating device.

28. A heating system as set forth in claim 27 wherein a joining fit is provided between the at least one through opening provided on the flange body for the heating device, and the heating device.

29. A heating system as set forth in claim 23 wherein the heating device is glued in the at least one through opening of the flange body.
